(19) United States
(12) Patent Application Publication
(10) Pub. No.: US 2013/0140327 A1
(43) Pub. Date: Jun. 6, 2013

(54) COLORANT DISPENSER

(71) Applicant: MICHAEL JAY MURPHY, Algonquin, IL (US)

(72) Inventor: MICHAEL JAY MURPHY, Algonquin, IL (US)

(21) Appl. No.: 13/309,820

(22) Filed: Dec. 2, 2011

(51) Int. Cl. B67D 7/06

(52) U.S. Cl. 222/144.5

(57) ABSTRACT

A colorant dispenser for use with bagged colorants includes a canister including a base and a top section. A switch is connected to the canister. A pump is adapted to be connected to the switch. The top section of the canister is configured to receive a bag containing a colorant or a cartridge for open colorants. The top section is configured to store a solvent. The pump is configured to dispense solvent or colorant depending on a position of the switch.

### BACKGROUND OF THE INVENTION

The present invention generally relates to colorant dispensers. More particularly, the present invention relates to colorant dispensers that dispense colorants directly from a bag or a canister reservoir.

Typically, the retail paint industry uses colorant dispensers to precisely add colorant to a base paint to create a customized color. The standard colorant dispensers typically include several containers, which house colorants a pump assembly for precisely dispensing the colorant into the base paint. The standard colorant dispensers are costly, slow acting, difficult to operate and repair. Furthermore, in conventional dispensers, the colorants were typically suspended in volatile dispersants such as oils or glycols. Due to government regulations limiting the amount of volatile organic compounds (VOC's) released in the atmosphere, the volatile dispersants are being reduced or eliminated in favor of water based dispersants. Water based dispersants are presently dispensed by computerized electronic units that are slow, expensive and costly to repair, as well as being very large (extremely big footprint) and subject to electric shortages. Unfortunately, the standard mechanical colorant dispensers are not designed to dispense water system colorants (they dry out in a few days) or accept bagged colorants, which would house water system colorant and prevent them from drying out.

As can be seen, there is a need for a dispenser that is easy to use, affordable, and easy to maintain. In addition, there is a need for a dispenser that can be used with bagged water system colorants that would allow the paint industry to become environmentally responsible.

### SUMMARY OF THE INVENTION

In one aspect of the present invention, a canister including a base and a top section; a switch is connected to the canister; a pump adapted to be connected to the switch; the top section of the canister is configured to receive a bag containing a colorant or a cartridge for open colorants; the top section is configured to store a solvent; and the pump is configured to dispense solvent or colorant depending on a position of the switch.

In another aspect of the present invention, a colorant dispenser including a canister including a base and a top section; a switch connected to the canister; a pump adapted to be connected to the switch; a cartridge attachable to the canister; the cartridge is to receive a non-bagged colorant; the top section is configured to store a solvent; the pump is configured to dispense solvent or colorant depending on a position of the switch.

These and other features, aspects and advantages of the present invention will become better understood with reference to the following drawings, description and claims.

### BRIEF DESCRIPTION OF THE DRAWINGS

FIG. 1 is a perspective rear view of a colorant dispenser according to an exemplary embodiment of the present invention showing the colorant dispenser having a colorant bag attached to the colorant dispenser;

FIG. 2 is a perspective rear view of the colorant dispenser of FIG. 1;

FIG. 3 is a perspective front view of the colorant dispenser of FIG. 1 showing the colorant dispenser in a colorant dispensing configuration;

FIG. 4 is a perspective front view of the colorant dispenser of FIG. 1 showing the colorant dispenser in a solvent dispensing configuration;

FIG. 5 is a cross section view of the colorant dispenser taken along line 5-5 in FIG. 3;

FIG. 6 is a cross section view of the colorant dispenser taken along line 6-6 in FIG. 3;

FIG. 7 is a perspective rear view of the colorant dispenser with attached cartridge according to another exemplary embodiment of the present invention;

FIG. 8 is an exploded perspective front view of the colorant dispenser and attachable cartridge of FIG. 7; and

FIG. 9 is a cross section view of the colorant dispenser taken along line 9-9 in FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a colorant dispenser for use with bagged and non bagged colorants.

FIG. 1 shows a colorant dispenser 10 according to an exemplary embodiment of the present invention. The colorant dispenser 10 may be adapted to be mounted on a conventional colorant dispenser base (not shown), for example, a standard round countertop dispenser or a floor standing colorant dispenser.

The colorant dispenser 10 may include a canister 31 having an L-shape and including a base 40 and a top section 32 vertically projecting from the base 40. The canister 31 may be made of a sturdy material, for example, plastic, metal, polymer, stainless steel, composite, or resin. The size of the canister 31 may depend on the size of the conventional colorant dispenser base (not shown).

A reservoir 22 (FIGS. 5-6) may be attached to the top section 32. The reservoir 22 may store a solvent 12 (FIGS. 5-6). The solvent 12 may be water or a commercially available solvent. The solvent 12 may be used to clean and lubricate the pump 24 to prevent the pump 24 from clogging.

A mounting block 20 may be secured to the top section 32. The mounting block 20 may be, for example, a ring, a bar, or a plurality of hooks.

The colorant dispenser 10 may be adapted to receive a bag 16 containing a colorant 14 (See FIGS. 5-6). The bag 16 may be a bladder, a sack, a soft container, or dual chambered mixing units. The bag 16 may include fasteners 18 that engage with the mounting block 20 to secure the bag 16 to the colorant dispenser 10. The bag 16 may be a commercially available container designed to hold and carry colorants for a standard colorant dispenser. The colorant 14 may be, for example, liquid paint pigments, liquid inks, liquid detergents, liquid soaps, liquid non-glycol and water based colorants, liquid low VOC water based colorants, or liquid non VOC water based colorants.

A pump 24 may be adapted to be operatively connected to an A-B switch 26. The pump 24 may be a standard pump that allows the user to pump the colorant 14 (FIGS. 5-6) out of the colorant dispenser 10.

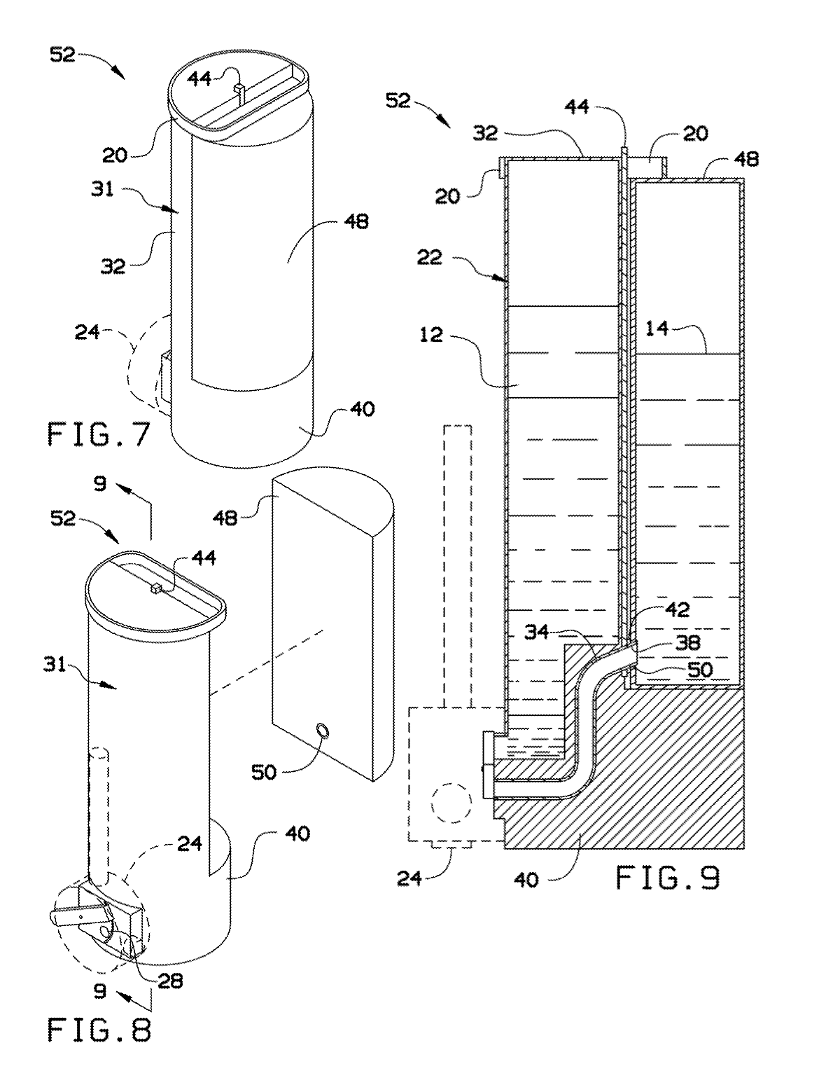

A release button 44 may be attached to the top section 32. The release button 44 may allow the user to disengage the bag 16 or cartridge 48 (FIGS. 7-9) from the canister 31.

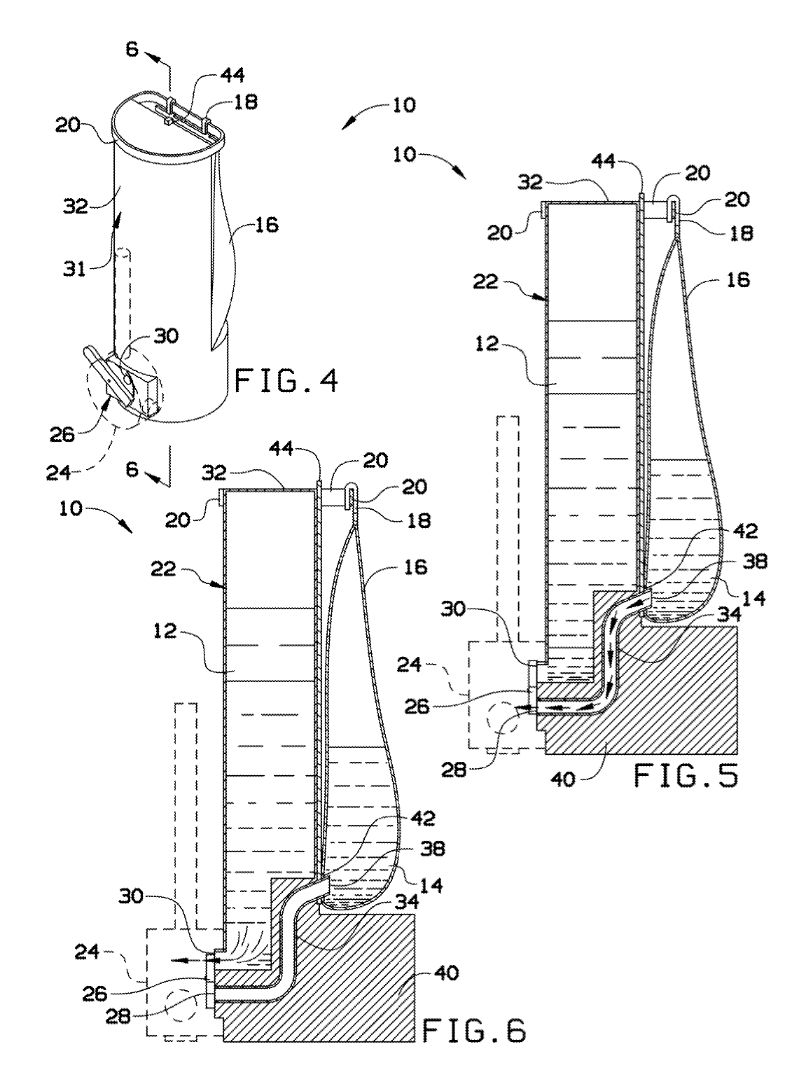

As can be seen in FIGS. 3-4, the A-B switch 26 may be operatively connected to the canister 31. The A-B switch 26 may allow the user to choose dispensing the colorant 14 from the bag 16 (FIG. 3), the cartridge 48 (FIGS. 7-9) or dispensing solvent (FIG. 4) stored inside the canister 31. The A-B switch 26 may be positioned anywhere on the canister 31.

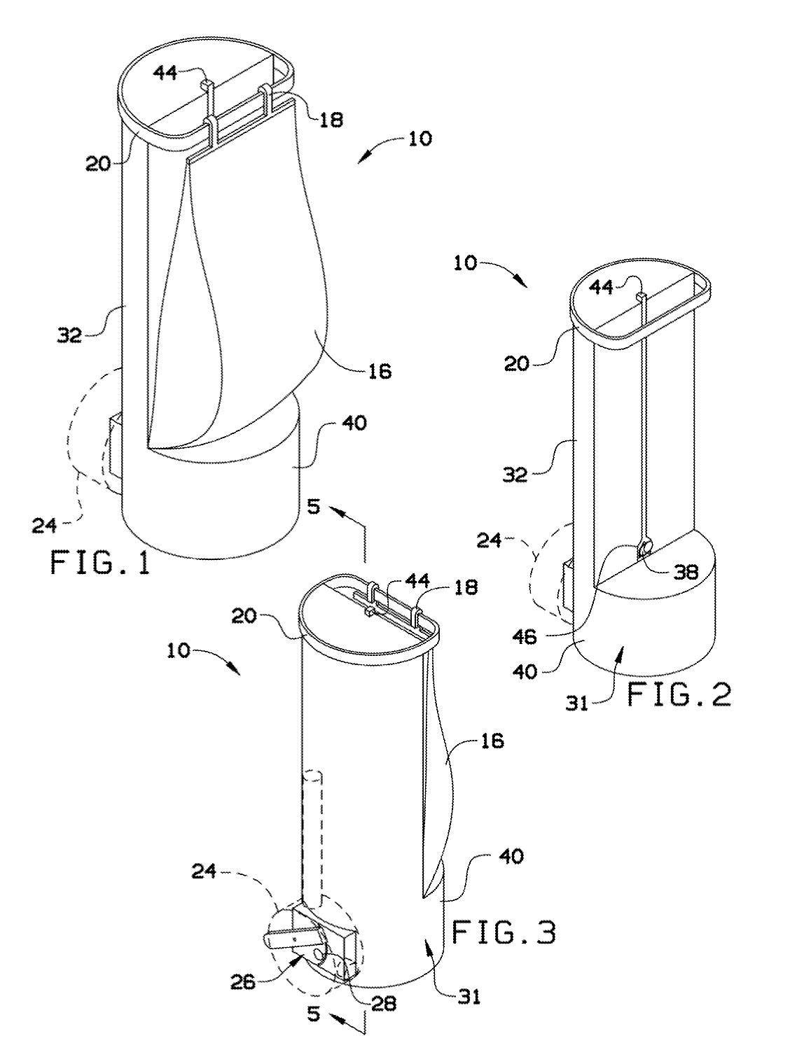

As can be seen in FIG. 2, the release button 44 may form part of a release mechanism 46 located near the base 40 of the canister 31. Pressing the release button 44 may activate the release mechanism 46 to disengage the bag 16 from the canister 31. A coupling device 38 may be operatively connected to the release mechanism 44. The coupling device 38 may connect the bag 16 or cartridge 48 (FIGS. 7-9) to the canister 31.

As can be seen in FIGS. 5-6, the coupling device 38 may be connected to a tubing 34. A gasket 42 may be placed between the coupling device 38 and the tubing 34 to maintain a fluid-tight seal. The tubing 34 may supply the colorant 14 to the pump 24. The tubing 34 may go through the base 40 connecting the coupling device 38 with the A-B switch 26 and then to the pump 24. A colorant output 28 and a solvent output 30 may be located on the canister 31. The colorant output 28 may supply colorant 14 to the pump 24. The solvent output 30 may supply solvent 12 to the pump 24.

FIG. 7 shows a colorant dispenser 52 according to another exemplary embodiment of the present invention. The colorant dispenser 52 may be similar to the colorant dispenser 10 except that, the colorant dispenser 52 may include a cartridge 48 attachable to the canister 31. The cartridge 48 may be used to store and dispense colorants 14 packaged in non-bagged containers, for example, current glycol base colorants.

As can been seen in FIGS. 8-9, a dispensing port 50 may be placed on the cartridge 48 to dispense the colorant 14 through the coupling device 38.

Referring to FIGS. 1-9, in an exemplary operation of the colorant dispenser 10 or 52, the user (not shown) may attach the bag 16 or cartridge container 48 to the coupling device 38 of the canister 31. The user may fill the reservoir with the solvent 12. The user may change the A-B switch 26 position to dispense colorant 14 or solvent 12 as needed. The user may clean the colorant dispenser 10, 52 by passing solvent through the pump 24.

The colorant dispenser 10, 52 may provide the user with the option of using water based colorants 14 straight from the bag 16 or continue to use current glycol base high VOC colorants by attaching the cartridge until their use is discontinued.

It should be understood, of course, that the foregoing relates to exemplary embodiments of the invention and that modifications may be made without departing from the spirit and scope of the invention as set forth in the following claims.

What is claimed is:

1. A colorant dispenser comprising:
a canister including a base and a top section;
a switch connected to the canister; and
a pump adapted to be connected to the switch; wherein
the top section of the canister is configured to receive a bag containing a colorant;
the top section is configured to store a solvent;
the pump is configured to dispense solvent or colorant depending on a position of the switch.

2. The colorant dispenser according to claim 1, wherein the canister has an L-shape

3. The colorant dispenser according to claim 1, further including a mounting block attached to the top section of the canister, the mounting block is adapted to engage with fasteners located on the bag.

4. The colorant dispenser according to claim 1, further including a coupling device connected to the canister and a tubing having one end connected to the coupling device and another end connected to the switch.

5. The colorant dispenser according to claim 1, further including a release mechanism located proximate the base, wherein the release mechanism disengages the bag from the canister.

6. A colorant dispenser comprising:
a canister including a base and a top section;
a switch connected to the canister;
a pump adapted to be connected to the switch; and
a cartridge attachable to the canister, wherein
the cartridge is to receive a non-bagged colorant;
the top section is configured to store a solvent;
the pump is configured to dispense solvent or colorant depending on a position of the switch.

7. The colorant dispenser according to claim 6, wherein the cartridge includes a dispensing port to dispense the non-bagged colorant into a coupling device located on the canister.

8. The colorant dispenser according to claim 6, further including a coupling device connected to the canister and a tubing having one end connected to the coupling device and another end connected to the switch.

9. The colorant dispenser according to claim 6, wherein the canister has an L-shape.
